(19) United States
(12) Patent Application Publication
(10) Pub. No.: US 2026/0024862 A1
(43) Pub. Date: Jan. 22, 2026

(54) ENERGY STORAGE APPARATUS

(71) Applicant: GS Yuasa International Ltd., Kyoto-shi (JP)

(72) Inventors: Kenji KAWATE, Kyoto-shi (JP); Nobuaki SHIBATA, Kyoto-shi (JP); Akira WADA, Kyoto-shi (JP); Shunsuke OKUTA, Kyoto-shi (JP)

(73) Assignee: GS Yuasa International Ltd., Kyoto-shi (JP)

(21) Appl. No.: 18/855,904

(22) PCT Filed: Apr. 3, 2023
(86) PCT No.: PCT/JP2023/013837

§ 371 Date: Oct. 10, 2024

(30) Foreign Application Priority Data
Apr. 13, 2022 (JP) 2022-066543

(51) Int. Cl. H01M 50/244; H01M 50/211; H01M 50/242; H01M 50/271

(52) U.S. Cl. CPC H01M 50/244; H01M 50/211; H01M 50/242; H01M 50/271

(57) ABSTRACT

An energy storage apparatus includes an energy storage unit that includes a plurality of energy storage devices arrayed in a first direction, a holding member that holds the energy storage unit, an outer case that accommodates the energy storage unit and the holding member, a first joint that joins the energy storage unit and the holding member by adhesion or welding, and a second joint that joins the holding member and the outer case by adhesion or welding.

### TECHNICAL FIELD

The present invention relates to an energy storage apparatus.

### BACKGROUND ART

Patent Document 1 discloses an energy storage apparatus in which a plurality of battery units each including a battery cell and a tray to which the battery cell is fixed are stacked and a plurality of trays are fixed by a through bolt and a nut.

### PRIOR ART DOCUMENT

### Patent Document

Patent Document 1: JP-A-2016-122633

### DISCLOSURE OF THE INVENTION

### Problems to be Solved by the Invention

In a configuration including a plurality of energy storage devices like the conventional energy storage apparatus, trays are fixed to each other by a fixing members such as a bolt and a nut in order to secure vibration resistance or impact resistance. However, in the energy storage apparatus having the above configuration, because a fixing member and a mounting portion that mounts the fixing member are required to be provided, there is a possibility that a volume occupation rate of the energy storage device in the entire energy storage apparatus decreases and an electric capacity per volume of the energy storage apparatus decreases. In addition, when the fixing member and the mounting portion are provided, because mass of the energy storage apparatus increases, a load generated during vibration or impact also increases, and the vibration resistance or the impact resistance may be degraded.

The present invention has been made by the inventor of the present application focusing on the above problems, and an object of the present invention is to provide an energy storage apparatus capable of preventing the decrease in the electric capacity while securing the vibration resistance or the impact resistance.

### Means for Solving the Problems

An energy storage apparatus according to one aspect of the present invention includes an energy storage unit that includes a plurality of energy storage devices arranged in a first direction, a holding member that holds the energy storage unit, an outer case that accommodates the energy storage unit and the holding member, a first joint that joins the energy storage unit and the holding member to each other by adhesion or welding, and a second joint that joins the holding member and the outer case to each other by adhesion or welding.

### Advantages of the Invention

According to the present invention, the energy storage apparatus capable of preventing the decrease in the electric capacity while securing the vibration resistance or the impact resistance can be provided.

### BRIEF DESCRIPTION OF THE DRAWINGS

FIG. 1 is a perspective view illustrating an appearance of an energy storage apparatus according to an embodiment.

FIG. 2 is an exploded perspective view illustrating each component when the energy storage apparatus of the embodiment is disassembled.

FIG. 3 is an exploded perspective view illustrating each component when an energy storage unit and a holding member of the embodiment are disassembled.

FIG. 4 is a sectional view illustrating a configuration in which the energy storage unit, the holding member, and a joint are disposed in an outer case of the embodiment.

### MODE FOR CARRYING OUT THE INVENTION

(1) An energy storage apparatus according to one aspect of the present invention includes an energy storage unit that includes a plurality of energy storage devices arrayed in a first direction, a holding member that holds the energy storage unit, an outer case that accommodates the energy storage unit and the holding member, a first joint that joins the energy storage unit and the holding member by adhesion or welding, and a second joint that joins the holding member and the outer case by adhesion or welding.

According to the energy storage apparatus of one aspect of the present invention, the energy storage unit and the holding member are joined by the adhesion or the welding, and the holding member and the outer case are joined by the adhesion or the welding. Accordingly, weight reduction of the energy storage apparatus can be achieved as compared with a case where a fixing member such as a bolt and a nut and a mounting portion that mounts the fixing member are provided and joined. When the weight reduction of the energy storage apparatus can be achieved, the load generated during the vibration or the impact can be reduced, so that vibration resistance or impact resistance can be secured. Furthermore, because a space can be saved as compared with the case where the fixing member and the mounting portion are provided, a decrease in a volume occupation rate of the energy storage device in the entire energy storage apparatus can be prevented and a decrease in electric capacity per volume of the energy storage apparatus can be prevented. As a result, the decrease in the electric capacity can be prevented while the vibration resistance or the impact resistance of the energy storage apparatus 1 is secured.

(2) In the energy storage apparatus described in (1), the energy storage apparatus may include a plurality of the first joints that joins the energy storage unit and a plurality of the holding members by adhesion or welding, in which the holding member may include the plurality of holding members.

According to the energy storage apparatus described in (2), the weight reduction and the space saving of the energy storage apparatus can be achieved in the plurality of holding members by joining the energy storage unit and the plurality of holding members by the adhesion or the welding. As a result, the decrease in the electric capacity can be further prevented while the vibration resistance or the impact resistance of the energy storage apparatus is more reliably secured.

(3) In the energy storage apparatus described in (1) or (2), the energy storage apparatus may include a third joint that joins a first energy storage device and a second energy storage device by adhesion or welding, in which the energy storage unit may include the first energy storage device and the second energy storage device disposed on one side in the first direction of the first energy storage device.

According to the energy storage apparatus described in (3), the first energy storage device and the second energy storage device can be more firmly fixed by bonding or welding the first energy storage device and the second energy storage device. As a result, the decrease in the electric capacity can be further prevented while the vibration resistance or the impact resistance of the energy storage apparatus is more reliably secured.

(4) In the energy storage apparatus described in any one of (1) to (3), the holding member may include a first holder that is opposite to the energy storage unit in the first direction, and the first joint may join the energy storage unit and the first holder.

In the energy storage apparatus described in (4), the holding member is joined to the energy storage unit in the first direction, so that expansion of the energy storage device can be prevented in the first direction. As a result, the decrease in the electric capacity can be further prevented while the vibration resistance or the impact resistance of the energy storage apparatus is more reliably secured.

(5) In the energy storage apparatus described in any one of (1) to (4), the outer case may include an outer case body and an outer case lid, the holding member may include a second holder that is opposite to at least one of the outer case body and the outer case lid, and the second joint may join at least one of the outer case body and the outer case lid and the second holder.

According to the energy storage apparatus described in (5), the second holder is opposite to at least one of the outer case body and the outer case lid, so that the joint between the outer case and the holding member is stabilized. As a result, the decrease in the electric capacity can be further prevented while the vibration resistance or the impact resistance of the energy storage apparatus is more reliably secured.

(6) In the energy storage apparatus described in (5), the outer case body and the outer case lid may be arrayed in a second direction intersecting with the first direction, the second holding member may be opposite to at least one of the outer case body and the outer case lid in the second direction, and the second joint may join at least one of the outer case body and the outer case lid and the second holder in the second direction.

According to the energy storage apparatus described in (6), during joining the outer case body and the outer case lid, at least one of the outer case body and the outer case lid and the second holder can be joined by utilizing force that sandwiches the holding member between the outer case body and the outer case lid, so that the outer case and the holding member can be easily joined. As a result, the decrease in the electric capacity can be further prevented while the vibration resistance or the impact resistance of the energy storage apparatus is more reliably secured.

(7) In the energy storage apparatus described in any one of (1) to (6), the holding member may include a pair of first holders disposed between the energy storage unit and a wall of the outer case on both sides in the first direction, and each of the pair of first holders may be disposed away from the wall so as to form a gap with the wall in the first direction.

According to the energy storage apparatus described in (7), the gap is formed between the holding member and the wall of the outer case in the first direction, so that an expansion margin can be secured when the energy storage device expands in the first direction. As a result, even when the energy storage device expands in the first direction, the decrease in the electric capacity can be further prevented while more reliably securing the vibration resistance or the impact resistance of the energy storage apparatus is more reliably secured.

Hereinafter, an energy storage apparatus according to an embodiment (including a modification) of the present invention will be described with reference to the drawings. The embodiment described below indicates a comprehensive or specific example. Numerical values, shapes, materials, components, dispositions of the components, connection forms of the components, and the like described in the following embodiment are merely examples, and are not intended to limit the present invention. In each of the drawings, dimensions and the like are not strictly illustrated.

In the following description and drawings, a protruding direction of a terminal of the energy storage device provided in the energy storage apparatus is defined as an X-axis direction. An arrangement direction of the plurality of energy storage devices and an arrangement direction of the first holding member and the second holding member forming the holding member are defined as a Y-axis direction. A direction in which the outer case body and the outer case lid are arranged in the outer case of the energy storage apparatus, an insertion and removal direction of the holding member with respect to the outer case body, or a vertical direction is defined as a Z-axis direction. The X-axis direction, the Y-axis direction, and the Z-axis direction intersect with one another (hereinafter, orthogonal to one another in the embodiment). Although it may be conceivable that the Z-axis direction is not the vertical direction depending on a mode of use, hereinafter the Z-axis direction is described as the vertical direction for convenience of explanation.

In the following description, an X-axis positive direction indicates an arrow direction side of the X-axis, and an X-axis negative direction indicates an opposite direction to the X-axis positive direction. The X-axis direction simply refers to both or one of the X-axis positive direction and the X-axis negative direction. The same applies to the Y-axis direction and the Z-axis direction. In the embodiment, the Y-axis direction is an example of a first direction, and the Z-axis direction is an example of a second direction. An expression indicating a relative direction or a posture such as parallel and orthogonal strictly also includes the case where the expression is not the direction or the posture. For example, two directions orthogonal to each other means not only that the concerned two directions are completely orthogonal to each other, but also that the two directions are substantially orthogonal to each other, namely, includes a difference of, for example, about several percent. In the following description, the expression “insulation” means “electric insulation”.

### Embodiment

### 1. General Description of Energy Storage Apparatus

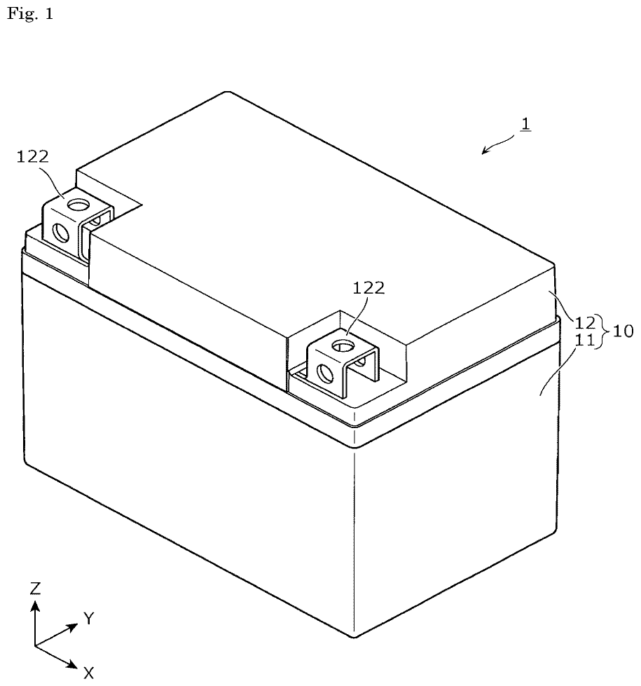

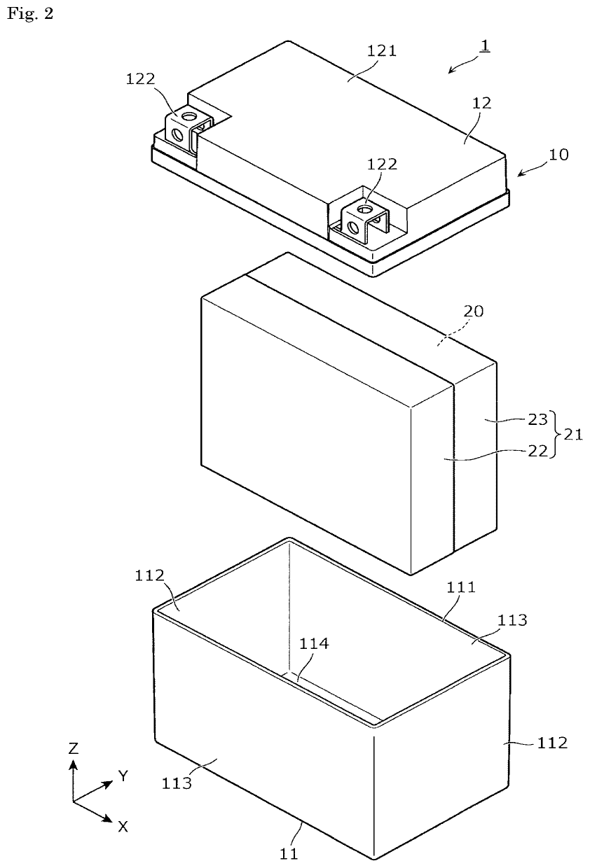

A general description of an energy storage apparatus 1 of the embodiment will be given with reference to FIGS. 1 and 2. FIG. 1 is a perspective view illustrating an appearance of the energy storage apparatus 1 of the embodiment. FIG. 2 is an exploded perspective view illustrating each component when the energy storage apparatus 1 of the embodiment is disassembled.

The energy storage apparatus 1 is an apparatus capable of charging electricity from an outside and discharging electricity to the outside, and has a substantially rectangular parallelepiped shape in the embodiment. The energy storage apparatus 1 is a battery module (assembled battery) used for a power storage application, a power supply application, and the like. Specifically, for example, the energy storage apparatus 1 is used as a battery for driving a moving body such as automobiles, motorcycles, watercrafts, vessels, snowmobiles, agricultural machines, construction machines, and railroad vehicles for electric railroad or starting an engine. Examples of the automobile include an electric vehicle (EV), a hybrid electric vehicle (HEV), a plug-in hybrid electric vehicle (PHEV), and a fossil fuel (gasoline, light oil, liquefied natural gas, and the like) automobile. Examples of the railway vehicle for the electric railway include a train, a monorail, a linear motor car, and a hybrid train including both a diesel engine and an electric motor. The energy storage apparatus 1 can also be used as a stationary battery or the like used for home use, business use, or the like.

As illustrated in FIG. 1 and FIG. 2, the energy storage apparatus 1 includes an energy storage unit 20, a holding member 21 that holds the energy storage unit 20 and an outer case 10 in which the energy storage unit 20 and the holding member 21 are accommodated. In addition to the energy storage unit 20 and the holding member 21, a bus bar electrically connected to the plurality of energy storage devices 20a, a bus bar plate that holds the bus bar, a fuse, a control board, and the like may be disposed inside the outer case 10, but illustration and description of these members are omitted.

The outer case 10 is a rectangular (substantially rectangular parallelepiped shape) case (module case) configuring an enclosure (outer shell) of the energy storage apparatus 1. The outer case 10 fixes the energy storage unit 20 and the like at predetermined positions, and protects these elements from impact or the like. The outer case 10 includes an outer case body 11 that accommodates the energy storage unit 20 and the holding member 21, and an outer case lid 12 that covers the energy storage unit 20 and the holding member 21 from above. The outer case body 11 and the outer case lid 12 are arranged in the Z-axis direction (second direction).

The outer case body 11 is a member (housing) having a bottomed rectangular cylindrical shape in which an upper portion is opened while an entire surface of a surface in the Z-axis positive direction is open, and an open portion (opening) of the outer case body is an opening 111. The opening 111 has a substantially quadrangular shape in plan view. The outer case lid 12 is a flat rectangular member that closes the opening 111 of the outer case body 11. The outer case body 11 and the outer case lid 12 are joined to each other by an adhesive, heat sealing (heat welding), ultrasonic welding, laser welding, screw bonding, or the like, whereby the inside of the outer case 10 is sealed. The outer case body 11 includes two first walls 112 that are opposite to each other on both side surfaces in the X-axis direction, two second walls 113 that are opposite to each other on both side surfaces in the Y-axis direction, and a third wall 114 that is disposed on a surface in the Z-axis negative direction.

Specifically, the first wall 112 is a rectangular and flat plate-like short side surface portion (short side wall) that forms a short side surface (short side wall) of the outer case body 11, and is disposed parallel to a YZ-plane. The first wall 112 is adjacent to the second wall 113 and the third wall 114, and has an outer surface area smaller than that of the second wall 113. The two first walls 112 are opposite to the energy storage unit 20 and the holding member 21 in the X-axis direction, and are disposed at positions where the energy storage unit 20 and the holding member 21 are sandwiched. The second wall 113 is a rectangular and flat plate-like long side surface (long side wall) that forms a long side surface (long side wall) of the outer case body 11, and is disposed parallel to an XZ-plane and extending in the X-axis direction. The second wall 113 is adjacent to the first wall 112 and the third wall 114, and has the outer surface area larger than that of the first wall 112. The two second walls 113 are opposite to the energy storage unit 20 and the holding member 21 in the Y-axis direction, and are disposed at positions where the energy storage unit 20 and the holding member 21 are sandwiched. The third wall 114 is a rectangular and flat plate-like bottom surface portion (bottom wall) that forms a bottom surface (bottom wall) of the outer case body 11, and is disposed in parallel to an XY-plane and extending in the X-axis direction. The third wall 114 is opposite to the energy storage unit 20 and the holding member 21 in the Z-axis direction, and is disposed at a position where the energy storage unit 20 and the holding member 21 are sandwiched between the third wall 114 and the outer case lid 12.

Depending on the shape and the like of the holding member 21, the outer case body 11 may have a pair of long side surfaces (long side walls) on both sides in the X-axis direction and a pair of short side surfaces (short side walls) on both sides in the Y-axis direction. The pair of first walls 112 may form long side surfaces (long side walls) of the outer case body 11, and the pair of second walls 113 may form short side surfaces (short side walls) of the outer case body 11.

The outer case lid 12 includes a fourth wall 121 on the surface of the outer case lid 12 in the Z-axis positive direction. The fourth wall 121 is a flat plate-like upper surface (upper wall) that forms an upper surface (upper wall) of the outer case lid 12 (outer case 10), and is disposed parallel to the XY-plane. The fourth wall 121 is opposite to the energy storage unit 20 and the holding member 21 in the Z-axis direction, and is disposed at a position where the energy storage unit 20 and the holding member 21 are sandwiched between the fourth wall 121 and the third wall 114 of the outer case body 11.

The outer case lid 12 further includes a pair of (positive electrode and negative electrode) external terminals 122 at both ends in the X-axis direction of the end in the Y-axis negative direction. The energy storage apparatus 1 charges electricity from the outside and discharges electricity to the outside through the pair of external terminals 122. When the outer case lid 12 is formed of resin, each of the external terminals 122 is integrated with the resin forming the outer case lid 12 by insert molding or the like. In each of the external terminals 122, an external device is electrically connected to a region that protrudes from the outer case lid 12 in the Z-axis positive direction and is exposed. In each of the external terminals 122, the bus bar or the like is joined to a region exposed from the outer case lid 12 in the Z-axis negative direction. As long as the external terminal 122 can be fixed to the outer case lid 12, the fixing is not limited to the insert molding, and the fixing may be performed by the fitting, the fixing may be performed using a fastening method such as a screw or caulking, the fixing may be performed by welding, or the fixing may be performed by an adhesive.

The outer case body 11 and the outer case lid 12 of the outer case 10 is formed of an insulating member such as polycarbonate (PC), polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), a polyamide (PA) resin, an ABS resin, or a composite material thereof or an insulation-coated metal. This enables the outer case 10 to prevent the energy storage device 20a and the like from contacting with a metal member of the outside and the like. The outer case 10 may be formed by a conductive member such as metal as long as an electrical insulation property of the energy storage device 20a and the like are maintained. The outer case body 11 and the outer case lid 12 may be formed of the same material or different materials.

### 2. Description of Energy Storage Unit and Holding Member

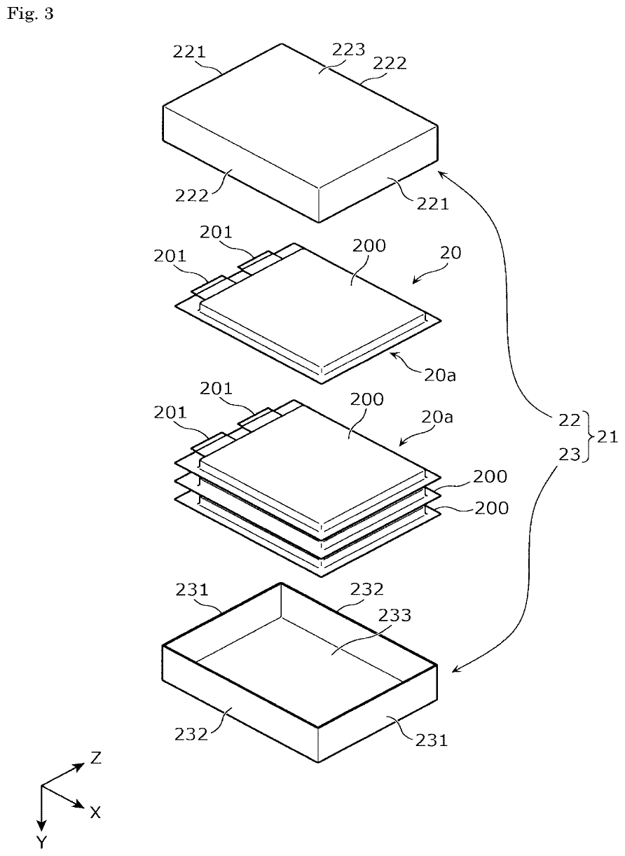

Details of the energy storage unit 20 and the holding member 21 will be described. FIG. 3 is an exploded perspective view illustrating each component when the energy storage unit 20 and the holding member 21 of the embodiment are disassembled. As illustrated in FIG. 3, the energy storage unit 20 includes a plurality of energy storage devices 20a arranged in the Y-axis direction (first direction).

The energy storage device 20a is a secondary battery (battery cell) that can charge and discharge the electricity, more specifically, is a nonaqueous electrolyte secondary battery such as a lithium ion secondary battery. In the embodiment, the energy storage device 20a is a pouch type energy storage device having a flat shape, and a plurality of (four in the embodiment) pouch type energy storage devices 20a are arranged side by side in the Y-axis direction. The energy storage device 20a is not limited to the pouch type energy storage device, but may be an energy storage device having a flat rectangular parallelepiped shape (square shape), a cylindrical shape, an oval columnar shape, an elliptic columnar shape, or the like, and a size and a shape of the energy storage device are not limited. The number of the arrayed energy storage devices 20a is also not particularly limited. The energy storage device 20a is not limited to the nonaqueous electrolyte secondary battery, but may be a secondary battery except for the nonaqueous electrolyte secondary battery or a capacitor. The energy storage device 20a is not the secondary battery, but may be a primary battery that can use stored electricity without being charged by a user. The energy storage device 20a may be a battery in which a solid electrolyte is used.

All the energy storage devices 20a included in the energy storage apparatus 1 have the same configuration, so that the configuration of one energy storage device 20a will be described in detail below. FIG. 3 illustrates the state in which three energy storage devices 20a are stacked on each other and one energy storage device 20a is disposed apart from each other. The energy storage device 20a includes a case 200 and a pair of terminals 201 (a positive electrode and a negative electrode), and an electrode assembly (not illustrated), an electrolyte solution (nonaqueous electrolyte) (not illustrated) and the like are accommodated in the case 200. As the electrolyte solution, a kind of the concerned electrolyte solution is not particularly limited as long as performance of the energy storage device 20a is not impaired, and a known material can be appropriately used.

The case 200 is a sheet-like outer case (exterior film) formed of a laminate film, and accommodates the electrode assembly, the electrolyte solution and the like in a sealed manner in a decompressed state. The case 200 is configured by stacking two rectangular laminate films in the Y-axis direction. The concerned two laminate films are joined (sealed) by thermal welding or the like with the pair of terminals 201 interposed therebetween. The laminate film is a flexible film formed of a plurality of layers including a metal layer of aluminum or the like and a resin layer of polypropylene (PP), polyethylene (PE) or the like, and the resin layer is disposed at a welded portion (seal portion). The case 200 may be configured by forming one sheet of laminate film into a bag shape and joining ends of the concerned laminate film to each other by thermal welding. When the energy storage device 20a is not the pouch type energy storage device, the case 200 may be formed of a plate-like member made of metal such as stainless steel, aluminum, an aluminum alloy, iron, or a plated steel plate.

A terminal 201 is a conductive plate-like member (lead plate) electrically connected to the electrode assembly, and is disposed to be exposed from the case 200 while penetrating the case 200. In the embodiment, a pair of terminals 201 arranged side by side in the Z-axis direction is disposed so as to protrude in the X-axis negative direction from the end in the X-axis negative direction of the case 200. Specifically, the positive terminal 201 is a lead terminal electrically connected to the positive electrode plate of the electrode assembly, and the negative terminal 201 is a lead terminal electrically connected to the negative electrode plate of the electrode assembly. That is, the terminal 201 is a metal terminal that leads out electricity stored in the electrode assembly to an external space of the energy storage device 20a and introduces electricity into an internal space of the energy storage device 20a in order to store electricity in the electrode assembly. One (for example, the positive electrode) of the terminals 201 may protrude from the end in the X-axis positive direction, and the other (for example, the negative electrode) may protrude from the end in the X-axis negative direction. The terminal 201 is made of aluminum, an aluminum alloy, copper, a copper alloy, or the like.

In FIG. 3, the terminal 201 is illustrated in a simplified state in which the terminal only protrudes from the case 200 in the X-axis negative direction, but the terminal 201 may extend and be bent toward the concerned adjacent energy storage device 20a and be connected (joined) to the terminal 201 of the adjacent energy storage device 20a. The terminal 201 may be electrically connected to the terminal 201 of the concerned adjacent energy storage device 20a by being connected (joined) to the conductive member such as the bus bar. With such a configuration, the plurality of energy storage devices 20a are connected to each other in series or in parallel. One of the pair of terminals 201 included in the energy storage device 20a at the end may extend to the external terminal 122 included in the energy storage apparatus 1 to be connected (joined) to the concerned external terminal 122, may be electrically connected to the external terminal 122 by the conductive member such as the bus bar, or the concerned terminal 201 itself may be an external terminal.

The electrode assembly is an energy storage element (power generating element) formed by laminating the positive electrode plate, the negative electrode plate, and the separator. The positive electrode plate is obtained by forming a positive active material layer on a current collecting foil made of metal such as aluminum or an aluminum alloy. The negative electrode plate is obtained by forming a negative active material layer on the current collecting foil made of metal such as copper or a copper alloy. A known material can be appropriately used as the active material used for the positive active material layer and negative active material layer as long as the positive active material and the negative active material can store and release the lithium ion. A microporous sheet made of resin, a nonwoven fabric, or the like can be used as the separator. In the embodiment, the electrode assembly is formed by laminating plates (the positive electrode plate and the negative electrode plate) in the Y-axis direction. The electrode assembly may be an electrode assembly in any form such as a winding-type electrode assembly formed by winding plates (a positive electrode plate and a negative electrode plate), a laminating-type (stacking-type) electrode assembly formed by laminating a plurality of plate-shaped electrode plates, or a bellows-type electrode assembly formed by folding plates in a bellows shape.

The holding member 21 is a box-shaped (substantially rectangular parallelepiped) case (housing) that accommodates the concerned plurality of energy storage devices 20a (energy storage units 20) and holds the plurality of energy storage devices 20a (energy storage units 20). The holding member 21 includes a first holding member 22 and a second holding member 23 that is assembled to the first holding member 22 and accommodates the plurality of energy storage devices 20a together with the first holding member 22. The first holding member 22 and the second holding member 23 are disposed on an outside of the plurality of energy storage devices 20a, fix the plurality of energy storage devices 20a at predetermined positions, and protect the plurality of energy storage devices 20a from impact or the like. The plurality of energy storage devices 20a are held by the first holding member 22 and the second holding member 23, whereby the plurality of energy storage devices 20a are fixed inside the first holding member 22 and the second holding member 23. In the embodiment, the first holding member 22 and the second holding member 23 are joined to each other by an adhesive, heat sealing (heat welding), ultrasonic welding, laser welding, screw bonding, or the like, but may not be joined.

The first holding member 22 and the second holding member 23 are formed of a member having an insulating property such as any resin material that can be used for the outer case 10. With such a configuration, the first holding member 22 and the second holding member 23 prevent conduction of the plurality of energy storage devices 20a with the conductive member such as an external metal member. However, in the case where such a configuration is not required or the like, the first holding member 22 and the second holding member 23 may be formed of the conductive member such as metal. The first holding member 22 and the second holding member 23 may be made of the same material or different materials.

The first holding member 22 is a bottomed rectangular cylindrical housing that is disposed in the Y-axis negative direction of second holding member 23 and includes the surface entirely opened in the Y-axis positive direction. The first holding member 22 includes a pair of first side walls 221 opposite to each other on side surfaces on both sides in the X-axis direction, a pair of second side walls 222 opposite to each other on side surfaces on both sides in the Z-axis direction, and a bottom wall 223 on the surface in the Y-axis negative direction.

The first side wall 221 is a flat plate-like rectangular wall (short side wall) that forms the short side surface (short side wall) of the first holding member 22 and is parallel to the YZ-plane, and is disposed at the position where the plurality of energy storage devices 20a are sandwiched in the X-axis direction. The first side wall 221 is adjacent to the second side wall 222 and the bottom wall 223, and has the outer surface area smaller than that of the second side wall 222. The second side wall 222 is a flat plate-like rectangular wall (long side wall) that forms the long side surface (long side wall) of the first holding member 22 and is parallel to the XY-plane, and is disposed at the position where the plurality of energy storage devices 20a are sandwiched in the Z-axis direction. The second side wall 222 is adjacent to the first side wall 221 and the bottom wall 223, and has the outer surface area larger than that of the first side wall 221. The bottom wall 223 is a flat plate-shaped rectangular wall (bottom wall) that forms the bottom surface (bottom wall) of the first holding member 22 and is parallel to the XZ-plane, and is opposed to the energy storage device 20a at the end in the Y-axis negative direction in the Y-axis direction and is in contact with the concerned energy storage device 20a.

The second holding member 23 is a bottomed rectangular cylindrical housing that is disposed in the Y-axis positive direction of first holding member 22 and in which the entire surface in the Y-axis negative direction is open. The second holding member 23 includes a pair of first side walls 231 opposite to each other on side surfaces on both sides in the X-axis direction, a pair of second side walls 232 opposite to each other on side surfaces on both sides in the Z-axis direction, and a bottom wall 233 on a surface in the Y-axis positive direction.

The first side wall 231 is a flat plate-like rectangular wall (short side wall) that forms the short side surface (short side wall) of the second holding member 23 and is parallel to the YZ-plane, and is disposed at the position where the plurality of energy storage devices 20a are sandwiched in the X-axis direction. The first side wall 231 is adjacent to the second side wall 232 and the bottom wall 233, and has the outer surface area smaller than that of the second side wall 232. The second side wall 232 is a flat plate-like rectangular wall (long side wall) that forms the long side surface (long side wall) of the second holding member 23 and is parallel to the XY-plane, and is disposed at the position where the plurality of energy storage devices 20a are sandwiched in the Z-axis direction. The second side wall 232 is adjacent to the first side wall 231 and the bottom wall 233, and has the outer surface area larger than that of the first side wall 231. The bottom wall 233 is a flat plate-shaped rectangular wall (bottom wall) that forms the bottom surface (bottom wall) of the second holding member 23 and is parallel to the XZ-plane, and is opposed to the energy storage device 20a at the end in the Y-axis positive direction in the Y-axis direction and is in contact with the concerned energy storage device 20a.

In the embodiment, the pair of first side walls 221 and the pair of first side walls 231 are in contact with and connected (joined) to each other, and the pair of second side walls 222 and the pair of second side walls 232 are in contact with and connected (joined) to each other. Thus, the first holding member 22 and the second holding member 23 are connected (joined). Depending on the shape and the like of the energy storage device 20a, the first holding member 22 may include the pair of long side surfaces (long side walls) on both sides in the X-axis direction and the pair of short side surfaces (short side walls) on both sides in the Z-axis direction. That is, the pair of first side walls 221 may form the long side surfaces (long side walls) of the first holding member 22, and the pair of second side walls 222 may form the short side surfaces (short side walls) of the first holding member 22. The same applies to the second holding member 23.

The bottom wall 223 of the first holding member 22 and the bottom wall 233 of the second holding member 23 are examples of the first holder. The second side wall 222 of the first holding member 22 and the second side wall 232 of the second holding member 23 are examples of the second holder. The bottom walls 223 and 233 (first holders) are disposed to be opposite to the energy storage unit 20 in the Y-axis direction (first direction). The first holding member 22 and the second holding member 23 include a pair of bottom walls 223 and 233 (first holders) disposed between the energy storage unit 20 and the wall (second wall 113) of the outer case 10 on both sides in the Y-axis direction (first direction). The second side walls 222 and 232 (second holders) are disposed so as to be opposite to at least one of the outer case body 11 and the outer case lid 12 in the Z-axis direction (second direction). In the embodiment, the pair of second side walls 222 (second holders) is disposed to be opposite to both the outer case body 11 and the outer case lid 12 in the Z-axis direction (second direction). The pair of second side walls 232 (second holders) is disposed so as to be opposite to both the outer case body 11 and the outer case lid 12 in the Z-axis direction (second direction).

### 3. Description of Arrangement Positions and Joint of Energy Storage Unit and Holding Member in Outer Case

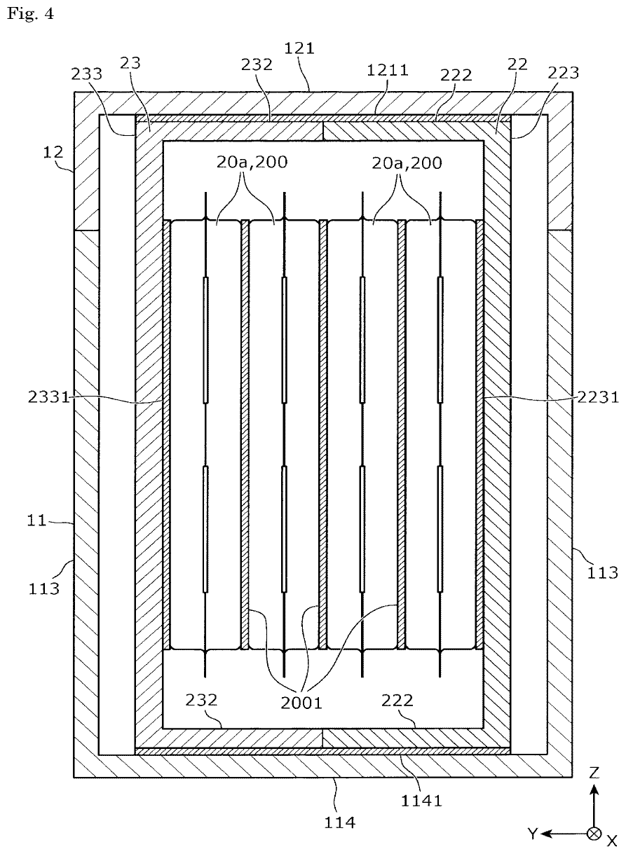

An arrangement positions and a joint of the energy storage unit 20 and the holding member 21 in the outer case 10 are described in detail. FIG. 4 is a sectional view illustrating a configuration in which the energy storage unit 20, the holding member 21, and the joint are disposed in the outer case 10 of the embodiment.

As illustrated in FIG. 4, first joints 2231 and 2331, second joints 1141 and 1211, and third joint 2001 are disposed in the outer case 10. The first joints 2231 and 2331 join the energy storage unit 20 and the holding member 21 to each other by adhesion or welding. Specifically, the first joint 2231 joins the energy storage unit 20 and the first holding member 22 of the holding member 21 to each other by adhesion or welding. The first joint 2331 joins the energy storage unit 20 and the second holding member 23 of the holding member 21 to each other by adhesion or welding. As described above, the energy storage apparatus 1 includes the plurality of first joints 2231 and 2331 that join the energy storage unit 20 to the first holding member 22 and the second holding member 23 that form the plurality of holding members by adhesion or welding.

The first joint 2231 joins the energy storage unit 20 and the bottom wall 223 (first holder) of the first holding member 22 to each other. Specifically, the first joint 2231 is the joint (fixing portion) that is formed between the energy storage device 20a disposed at the end of the energy storage unit 20 in the Y-axis negative direction and the bottom wall 223 (first holder) of the first holding member 22. The first joint 2231 is disposed between the surface of the concerned energy storage device 20a in the Y-axis negative direction and the surface of the bottom wall 223 (first holder) in the Y-axis positive direction, and joins the concerned energy storage device 20a and the bottom wall 223 (first holder) to each other by adhesion or welding.

The first joint 2331 joins the energy storage unit 20 and the bottom wall 233 (first holder) of the second holding member 23 to each other. Specifically, the first joint 2331 is the joint (fixing portions) that is formed between the energy storage devices 20a disposed at the end of the energy storage unit 20 in the Y-axis positive direction and the bottom walls 233 (first holders) of the second holding member 23. The first joint 2331 is disposed between the surface in the Y-axis positive direction of the concerned energy storage device 20a and the surface of the bottom wall 233 (first holder) in the Y-axis negative direction, and joins the concerned energy storage device 20a and the bottom wall 233 (first holder) to each other by adhesion or welding.

In the embodiment, the first joints 2231 and 2331 are adhesives that bonds the energy storage unit 20 and the holding member 21 to each other. The adhesive is applied to the surfaces of the energy storage devices 20a opposite to the bottom walls 223 and 233 (first holders) in the Y-axis direction or the surfaces of the bottom walls 223 and 233 (first holders) opposite to the energy storage devices 20a in the Y-axis direction, whereby the energy storage unit 20 and the holding member 21 (the first holding member 22 and the second holding member 23) are joined (fixed) to each other by bonding the surfaces to each other.

A range of the first joints 2231 and 2331, namely, the range where the adhesive is applied is not particularly limited, but the adhesive is preferably applied over the entire surface of the energy storage device 20a opposite to the bottom walls 223 and 233 (first holders) or the surfaces of the bottom walls 223 and 233 (first holders) in the Y-axis direction. In the energy storage device 20a or the bottom walls 223 and 233 (first holders), the adhesive may be applied to a central portion or an outer peripheral portion of the energy storage device 20a or the bottom walls 223 and 233 (first holders) as viewed in the Y-axis direction. The first joints 2231 and 2331 may have a stripe shape, an X-shape, a Y-shape, an annular shape, or the like as viewed in the Y-axis direction.

The method for joining (fixing) the energy storage device 20a and the holding member 21 is not limited to adhesion using the adhesive, and adhesion may be performed using a double-sided tape or the like. The energy storage device 20a and the holding member 21 may be joined (fixed) by welding (thermal welding, welding, and the like), and in this case, parts (portions where the energy storage device 20a and the holding member 21 are melted) of the energy storage device 20a and the holding member 21 become the first joints 2231 and 2331. That is, the first joints 2231 and 2331 may be formed of a member (an adhesive, a double-sided tape or the like) separate from the energy storage device 20a and the holding member 21, or a region (a welded portion or the like) integrally formed with the energy storage device 20a and the holding member 21. When the energy storage device 20a and the holding member 21 are integrated by welding (thermal welding or the like), the energy storage device and the holding member are more firmly joined (fixed) to each other. In particular, when the case 200 of the energy storage device 20a is an outer case formed of a laminate film, the resin layer formed on the surface of the outer case has good wettability of the adhesive, good bondability to an adhesive surface of the double-sided tape, easy welding with the holding member 21, and further strong adhesion between the energy storage device 20a and the holding member 21 can be achieved.

The second joints 1141 and 1211 join the holding member 21 and the outer case 10 to each other by the adhesion or the welding. The second joints 1141 and 1211 join at least one (in the embodiment, both) of the outer case body 11 and the outer case lid 12 to the second side wall 222 (second holder) of the first holding member 22 and the second side wall 232 (second holder) of the second holding member 23.

The second joint 1141 joins the second side wall 222 (second holder) in the Z-axis negative direction included in the first holding member 22 and the second side wall 232 (second holder) in the Z-axis negative direction included in the second holding member 23 to the outer case body 11. Specifically, the second joint 1141 is the joint (fixing portion) that is formed between the concerned second side wall 222 (second holder) of the first holding member 22 and the concerned second side wall 232 (second holder) of the second holding member 23 and the third wall 114 included in the outer case body 11. The second joint 1141 is disposed between the surfaces in the Z-axis negative direction of the concerned second side walls 222 and 232 (second holders) and the surface in the Z-axis positive direction of the third wall 114, and joins the concerned second side walls 222 and 232 (second holders) and the third wall 114 by the adhesion or the welding.

In the embodiment, the second joint 1141 is the adhesive that bonds the concerned second side wall 222 (second holder) of the first holding member 22 and the concerned second side wall 232 (second holder) of the second holding member 23 to the third wall 114 of the outer case body 11 of the outer case 10. That is, the adhesive is applied to the surfaces of the concerned second side walls 222 and 232 (second holders) that is opposite to the third wall 114 in the Z-axis direction or the surfaces of the third wall 114 that is opposite to the concerned second side walls 222 and 232 (second holders) in the Z-axis direction, and the first holding member 22 and the second holding member 23 are joined (fixed) to the outer case body 11 by bonding these surfaces to each other.

The range of the second joint 1141, namely, the range where the adhesive is applied is not particularly limited, but the adhesive is preferably applied over the entire surface of the second side walls 222 and 232 (second holder) opposite to the third wall 114 in the Z-axis direction or the entire surface of the third wall 114 opposite to the second side walls 222 and 232 (second holder) in the Z-axis direction. In the second side walls 222 and 232 or the outer case body 11 as viewed in the Z-axis direction, the adhesive may be applied to the central portion or the outer peripheral portion of the second side walls 222 and 232 or the third wall 114. The shape of the second joint 1141 as viewed from the Z-axis direction may be a stripe shape, an X-shape, a Y-shape, an annular shape, or the like. The technique for joining (fixing) the first holding member 22 and the second holding member 23 to the outer case body 11 is not limited to the bonding by the adhesive, and the first holding member and the second holding member may be bonded (stuck) to each other by the double-sided tape or the like, or joined (fixed) to each other by welding (thermal welding, welding, and the like) or the like. Details are the same as those of the first joints 2231 and 2331. When the first holding member 22 and the second holding member 23 are integrated with the outer case body 11 by welding (heat welding or the like), the first holding member 22 and the second holding member 23 and the outer case body 11 are more firmly joined (fixed) to each other.

The second joint 1211 joins the second side wall 222 (second holder) in the Z-axis positive direction included in the first holding member 22 and the second side wall 232 (second holder) in the Z-axis positive direction included in the second holding member 23 to the outer case lid 12. Specifically, the second joint 1211 is the joint (fixing portion) that is formed between the concerned second side wall 222 (second holder) of the first holding member 22 and the concerned second side wall 232 (second holder) of the second holding member 23 and the fourth wall 121 included in the outer case lid 12. The second joint 1211 is disposed between the surfaces in the Z-axis positive direction of the concerned second side walls 222 and 232 (second holders) and the surfaces in the Z-axis negative direction of the fourth wall 121, and joins the concerned second side walls 222 and 232 (second holders) and the fourth wall 121 to each other by the adhesion or the welding.

In the embodiment, the second joint 1211 is the adhesive that bonds the concerned second side wall 222 (second holder) of the first holding member 22 and the concerned second side wall 232 (second holder) of the second holding member 23 to the fourth wall 121 of the outer case lid 12 of the outer case 10. The adhesive is applied to the surfaces of the concerned second side walls 222 and 232 (second holders) that are opposite to the fourth wall 121 in the Z-axis direction or the surfaces of the fourth wall 121 that are opposite to the second side walls 222 and 232 (second holders) in the Z-axis direction, and the first holding member 22 and the second holding member 23 are joined (fixed) to the outer case lid 12 by bonding these surfaces to each other.

The range of the second joint 1211, namely, the range where the adhesive is applied is not particularly limited, but the adhesive is preferably applied over the entire surface of the second side walls 222 and 232 (second holder) opposite to the fourth wall 121 in the Z-axis direction or the entire surface of the fourth wall 121 opposite to the second side walls 222 and 232 (second holder) in the Z-axis direction. In the second side walls 222 and 232 or the outer case lid 12 as viewed in the Z-axis direction, the adhesive may be applied to the central portion or the outer peripheral portion of the second side walls 222 and 232 or the fourth wall 121. The shape of the second joint 1211 as viewed from the Z-axis direction may be a stripe shape, an X-shape, a Y-shape, an annular shape, or the like. The technique for joining (fixing) the first holding member 22 and the second holding member 23 to the outer case lid 12 is not limited to the bonding by the adhesive, and the first holding member and the second holding member may be bonded to each other by the double-sided tape or the like, or joined (fixed) to each other by welding (thermal welding, welding, and the like) or the like. Details are the same as those of the first joints 2231 and 2331. When the first holding member 22 and the second holding member 23 are integrated with the outer case lid 12 by welding (heat welding or the like), the first holding member 22 and the second holding member 23 and the outer case lid 12 are more firmly joined (fixed) to each other.

The third joint 2001 joins two adjacent energy storage devices 20a out of the plurality of energy storage devices 20a by the adhesion or the welding. Specifically, the third joint 2001 is the joint (fixing portion) that is formed between the surface in the Y-axis positive direction included in the energy storage device 20a and the surface in the Y-axis negative direction of the energy storage device 20a that is disposed adjacently to the concerned energy storage device 20a in the Y-axis positive direction. The third joint 2001 is disposed between the surface in the Y-axis positive direction of the concerned energy storage device 20a and the surface in the Y-axis negative direction of the energy storage device 20a adjacently to the concerned energy storage device 20a in the Y-axis positive direction, and joins the concerned energy storage device 20a and the energy storage device 20a adjacently to the concerned energy storage device 20a to each other by the adhesion or the welding. As described above, the energy storage unit 20 includes the third joint 2001.

In the embodiment, the third joint 2001 is formed between the surfaces of two energy storage devices 20a adjacently to each other in the Y-axis direction among the plurality of energy storage devices 20a, and the third joint 2001 is formed of the adhesive that bonds the concerned two energy storage devices 20a to each other. The adhesive is applied to the surfaces of the concerned two energy storage devices 20a opposite to each other and bonds the two energy storage devices to each other, whereby the concerned two energy storage devices 20a are joined (fixed) to each other.

The range of the third joint 2001, namely, the range where the adhesive is applied is not particularly limited, but the adhesive is preferably applied to the entire surface in the Y-axis direction of the energy storage device 20a. The adhesive may be applied to the central portion or the outer peripheral portion of the surface in the Y-axis direction of the energy storage device 20a as viewed in the Y-axis direction. The shape of the third joint 2001 as viewed in the Y-axis direction may be a stripe shape, an X shape, a Y shape, an annular shape, or the like. The technique for joining (fixing) the energy storage devices 20a to each other is not limited to the bonding using the adhesive, but the energy storage devices may be bonded to each other by the double-sided tape or the like, or joined (fixed) by welding (thermal welding, welding, or the like) or the like. Details are the same as those of the first joints 2231 and 2331. When the energy storage devices 20a are integrated by welding (thermal welding or the like), the energy storage devices are more firmly joined (fixed) to each other.

Each of the pair of bottom walls 223 and 233 (first holders) is disposed away from the wall (second wall 113) of the outer case 10 such that a gap is formed between each of the bottom walls 223 and 233 and the wall (second wall 113) of the outer case 10 in the Y-axis direction (first direction). Specifically, the bottom wall 223 (first holder) of the first holding member 22 is disposed away from the second wall 113 such that the gap is formed between the bottom wall 223 and the second wall 113 in the Y-axis negative direction of the outer case body 11. The first holding member 22 is disposed so as to be separated from the surface (the second wall 113 of the outer case body 11) such that the gap is formed between the bottom wall 223 (first holder) and the surface (the second wall 113 of the outer case body 11) opposite to the outer case 10 in the Y-axis direction. The bottom wall 233 (first holder) of the second holding member 23 is disposed away from the second wall 113 such that the gap is formed between the bottom wall 233 and the second wall 113 in the Y-axis positive direction of the outer case body 11. The second holding member 23 is disposed so as to be spaced apart from the surface (the second wall 113 of the outer case body 11) such that the gap is formed between the bottom wall 233 (first holder) and the surface (the second wall 113 of the outer case body 11) opposite to the outer case 10 in the Y-axis direction.

The pair of first side walls 221 of the first holding member 22 and the pair of first side walls 231 of the second holding member 23 are separated from the pair of the first wall 112 of the outer case body 11, but may be brought into contact with each other, or joined (fixed) to each other by the adhesion, the welding (heat welding or the like) or the like. One of the pair of first side walls 221 and 231 may be separated from one of the pair of first walls 112, and the other of the first side walls 221 and 231 and the other of the first walls 112 may be in contact with (and joined to) each other. The first side wall 221 and the first wall 112 may be separated from each other, and the first side wall 231 and the first wall 112 may be brought into contact (and joined) with each other, or the first side wall 221 and the first wall 112 may be brought into contact (and joined) with each other and the first side wall 231 and the first wall 112 may be separated from each other. The joining technique in the case where the first side walls 221, 231 and the first wall 112 are joined to each other is similar to the above-described joining technique in the joints of the first joints 2231 and 2331 and the like.

### 4. Description of Effects

As described above, the energy storage apparatus 1 of the present invention includes the energy storage unit 20 that includes the plurality of energy storage devices 20a arranged in the Y-axis direction (first direction), the holding member 21 that holds the energy storage unit 20, and the outer case 10 that accommodates the energy storage unit 20 and the holding member 21. The energy storage apparatus 1 includes the first joints 2231, 2331 that join the energy storage unit 20 and the holding member 21 to each other by the adhesion or the welding and the second joints 1141, 1211 that join the holding member 21 and the outer case 10 to each other by the adhesion or the welding. In this manner, the energy storage unit 20 and the holding member 21 are joined to each other by the adhesion or the welding, and the holding member 21 and the outer case 10 are joined to each other by the adhesion or the welding. Accordingly, the weight reduction of the energy storage apparatus 1 can be achieved as compared with the case where the joint is performed by providing a fixing member such as a bolt and a nut and a mounting portion that mounts the fixing member. When the weight reduction of the energy storage apparatus 1 can be achieved, the load generated during vibration or impact can be reduced, so that vibration resistance or impact resistance can be secured. Furthermore, the space can be saved as compared with the case where the fixing member and the amounting portion are provided, so that the decrease in the volume occupation rate of the energy storage device 20a with respect to the entire energy storage apparatus 1 can be prevented and the decrease in the electric capacity per volume of the energy storage apparatus 1 can be prevented. As a result, the decrease in the electric capacity can be prevented while the vibration resistance or the impact resistance of the energy storage apparatus 1 is secured.

The energy storage apparatus 1 includes the plurality of first joints 2231, 2331 that join the energy storage unit 20 and the plurality of holding members (the first holding member 22 and the second holding member 23) to each other by the adhesion or the welding, whereby weight reduction and space saving of the energy storage apparatus 1 can be achieved in the plurality of holding members. That is, in the plurality of holding members (the first holding member 22 and the second holding member 23), the fixing member such as the bolt and the nut, and the mounting portion that mounts the fixing member become unnecessary, and the decrease in the volume occupation rate of the energy storage devices 20a can be further prevented in the entire energy storage apparatus 1. As a result, the decrease in the electric capacity can be further prevented while the vibration resistance or the impact resistance of the energy storage apparatus 1 is more reliably secured.

The energy storage unit 20 includes the third joint 2001 that joins two energy storage devices 20a adjacently to each other out of the plurality of energy storage devices 20a by the adhesion or the welding, so that the energy storage devices 20a can be more firmly fixed to each other. As a result, the decrease in the electric capacity can be further prevented while the vibration resistance or the impact resistance of the energy storage apparatus 1 is more reliably secured.

The holding member 21 includes the bottom walls 223 and 233 (first holders) disposed to be opposite to the energy storage unit 20 in the Y-axis direction (first direction), and the first joints 2231 and 2331 join the energy storage unit 20 and the bottom walls 223 and 233 (first holders), so that the expansion of the energy storage device 20a in the Y-axis direction (first direction) can be prevented. The holding member 21 can be joined to a region having a relatively large area of the energy storage unit 20, so that joint strength between the energy storage unit 20 and the holding member 21 can be improved. As a result, the decrease in the electric capacity can be further prevented while the vibration resistance or the impact resistance of the energy storage apparatus 1 is more reliably secured.

The outer case 10 includes the outer case body 11 and the outer case lid 12, and the holding member 21 includes the second side walls 222 and 232 (second holders) that are opposite to at least one of the outer case body 11 and the outer case lid 12. The second joints 1141 and 1211 join at least one of the outer case body 11 and the outer case lid 12 and the second side walls 222 and 232 (second holders) to each other. With such a configuration, the second side walls 222 and 232 (second holders) are opposite to at least one of the outer case body 11 and the outer case lid 12, so that the joint between the outer case 10 and the holding member 21 is stabilized. As a result, the decrease in the electric capacity can be further prevented while the vibration resistance or the impact resistance of the energy storage apparatus 1 is more reliably secured.

The outer case 10 includes the outer case body 11 and the outer case lid 12 arranged in the Z-axis direction (second direction), and the holding member 21 includes the second side walls 222 and 232 (second holders) arranged to be opposite to at least one of the outer case body 11 and the outer case lid 12 in the Z-axis direction (second direction). The second joints 1141 and 1211 join at least one of the outer case body 11 and the outer case lid 12 and the second side walls 222 and 232 (second holders) to each other. With such a configuration, at least one (both in this embodiment) of the outer case body 11 and the outer case lid 12 and the second side walls 222 and 232 (second holders) can be joined to each other using force that sandwiches the holding member 21 between the outer case body 11 and the outer case lid 12, so that the outer case 10 and the holding member 21 can be easily joined to each other. As a result, the decrease in the electric capacity can be further prevented while the vibration resistance or the impact resistance of the energy storage apparatus 1 is more reliably secured.

The holding member 21 includes the pair of bottom walls 223 and 233 (first holders) disposed between the energy storage unit 20 and the wall (second wall 113) of the outer case 10 on both sides in the Y-axis direction (first direction). Each of the pair of bottom walls 223 and 233 (first holders) is disposed away from the second wall 113 so as to form the gap with the second wall 113 in the Y-axis direction (first direction). With such a configuration, an expansion allowance can be secured when the energy storage device 20a expands in the Y-axis direction (first direction). As a result, even when the energy storage device 20a expands in the Y-axis direction (first direction), the decrease in the electric capacity can be further prevented while more reliably securing the vibration resistance or the impact resistance of the energy storage apparatus 1 is more reliably secured.

Although the energy storage apparatus 1 of the embodiment is described above, the present invention is not limited to the embodiment. The embodiment disclosed herein is illustrative in all respects and is not restrictive, and the scope of the present invention includes all modifications within the meaning and scope equivalent to the claims.

In the embodiment, both the first joints 2231 and 2331 are disposed and joined to the energy storage unit 20 and the holding member 21. However, only one of the first joints 2231 and 2331 may be disposed and joined to the energy storage unit 20 and the holding member 21 by the one of the first joints 2231 and 2331. In this case, the holding member 21 may include both the first holding member 22 and the second holding member 23, or include only one of the first holding member 22 and the second holding member 23.

In the embodiment, the energy storage devices 20a included in the energy storage unit 20 includes and the holding members 21 are joined to each other, so that the energy storage unit 20 and the holding members 21 are joined to each other. However, the energy storage unit 20 of the energy storage unit 20 and the holding member 21 may be joined to each other by joining a member (an insulating sheet covering the energy storage device 20a, a spacer, a binding member such as an end plate, or the like) other than the energy storage devices 20a to the holding member 21.

In the embodiment, by way of example, the energy storage unit 20 includes the third joints 2001 that join all of two energy storage devices 20a adjacently to each other out of the plurality of energy storage devices 20a. However, the energy storage unit 20 may not include any one of the third joints 2001, or may not include all the third joints 2001 and not join the two adjacent energy storage devices 20a to each other.

In the embodiment, by way of example, the first joints 2231 and 2331 that join the energy storage unit 20 and the bottom walls 223 and 233 (first holders) disposed opposite to the energy storage unit 20 in the first direction in the holding member 21 are disposed. However, a first joint that joins the energy storage unit 20 and other regions (the first side walls 221, 231, the second side walls 222, 232, or the like) of the holding member 21 to each other may be disposed. In this case, the holding member 21 may not include one or both of the bottom walls 223 and 233 as long as the holding member can hold the energy storage unit 20.

In the embodiment, by way of example, the second joints 1141 and 1211 that join the outer case body 11 and the outer case lid 12 to the second side walls 222 and 232 (second holders) disposed opposite to the outer case body 11 and the outer case lid 12 out of the holding members 21 in the second direction are disposed. However, only one of the second joints 1141 and 1211 may be disposed, and only one of the outer case body 11 and the outer case lid 12 may be joined to the holding member 21. A second joint that joins at least one of the outer case body 11 and the outer case lid 12 and other regions (the bottom walls 223 and 233, the first side walls 221 and 231, or the like) of the holding member 21 to each other may be disposed. In this case, the holding member 21 may not include some side walls or all side walls out of the pair of second side walls 222 and the pair of second side walls 232 as long as the holding member 21 can hold the energy storage unit 20.

In the embodiment, as long as the holding member 21 is configured to hold the energy storage unit 20, the holding member may not include some side walls or all side walls out of the pair of first side walls 221 and the pair of first side walls 231.

In the embodiment, by way of example, the bottom walls and 233 (first holders) are disposed away from each other such that the gap is formed between the bottom walls 223 and the outer case 10 (outer case body 11) in the first direction. In this case, widths of the respective gaps may be different. The gap may not be formed between one or both of the bottom walls 223 and 233 (first holders) and the outer case 10 (outer case body 11) in the first direction. In this case, one or both of the bottom walls 223 and 233 (first holders) may be joined to the outer case 10 (outer case body 11) by the adhesion or the welding.

A mode constructed by any combination of the components included in the embodiment is also included in the scope of the present invention.

### INDUSTRIAL APPLICABILITY

The present invention can be applied to the energy storage apparatus including the energy storage device such as a lithium ion secondary battery.

### DESCRIPTION OF REFERENCE SIGNS

1: energy storage apparatus
10: outer case
11: outer case body
12: outer case lid
20: energy storage unit
20a: energy storage device
21: holding member
22: first holding member
23: second holding member
111: opening
112: first wall
113: second wall
114: third wall
121: fourth wall
122: external terminal
200: case
201: terminal
221, 231: first side wall
222, 232: second side wall (second holder)
223, 233: bottom wall (first holder)
1141, 1211: second joint
2001: third joint
2231, 2331: first joint

1. An energy storage apparatus, comprising:
an energy storage unit;
a holding member that holds the energy storage unit;
an outer case configured to accommodate the energy storage unit and the holding member;
a first joint that joins the energy storage unit and the holding member by adhesion or welding; and
a second joint that joins the holding member and the outer case adhesion or welding,
wherein the energy storage unit includes a plurality of energy storage devices arrayed in a first direction.

2. The energy storage apparatus according to claim 1, wherein the holding member is provided in a plurality, and the first joint is provided in a plurality such that the plurality of first joints joins the energy storage unit and the plurality of holding members by adhesion or welding.

3. The energy storage apparatus according to claim 1, further comprising:
a third joint that joins a first energy storage device of the energy storage devices in the energy storage unit and a second energy storage device of the energy storage devices in the energy storage unit by adhesion or welding,
wherein the first energy storage device and the second energy storage device are positioned on one side in the first direction of the first energy storage device.

4. The energy storage apparatus according to claim 1, wherein the holding member includes a holder that is opposite to the energy storage unit in the first direction, and the first joint joins the energy storage unit and the holder.

5. The energy storage apparatus according to claim 1, wherein the outer case includes an outer case body and an outer case lid, the holding member includes a holder that is opposite to at least one of the outer case body and the outer case lid, and the second joint joins at least one of the outer case body and the outer case lid and the holder.

6. The energy storage apparatus according to claim 5, wherein the outer case body and the outer case lid are arrayed in a second direction intersecting with the first direction, the holder is opposite to at least one of the outer case body and the outer case lid in the second direction, and the second joint joins at least one of the outer case body and the outer case lid and the holder in the second direction.

7. The energy storage apparatus according to claim 1, wherein the holding member includes a pair of holders positioned between the energy storage unit and a wall of the outer case on both sides in the first direction, and each of the pair of holders is positioned away from the wall and forms a gap with the wall in the first direction.

8. The energy storage apparatus according to claim 2, further comprising:
a third joint that joins a first energy storage device of the energy storage devices in the energy storage unit and a second energy storage device of the energy storage devices in the energy storage unit by adhesion or welding,
wherein the first energy storage device and the second energy storage device are positioned on one side in the first direction of the first energy storage device.

9. The energy storage apparatus according to claim 2, wherein the holding member includes a holder that is opposite to the energy storage unit in the first direction, and the first joint joins the energy storage unit and the holder.

10. The energy storage apparatus according to claim 2, wherein the outer case includes an outer case body and an outer case lid, the holding member includes a holder that is opposite to at least one of the outer case body and the outer case lid, and the second joint joins at least one of the outer case body and the outer case lid and the holder.

11. The energy storage apparatus according to claim 10, wherein the outer case body and the outer case lid are arrayed in a second direction intersecting with the first direction, the holder is opposite to at least one of the outer case body and the outer case lid in the second direction, and the second joint joins at least one of the outer case body and the outer case lid and the holder in the second direction.

12. The energy storage apparatus according to claim 2, wherein the holding member includes a pair of holders positioned between the energy storage unit and a wall of the outer case on both sides in the first direction, and each of the pair of holders is positioned away from the wall and forms a gap with the wall in the first direction.

13. The energy storage apparatus according to claim 3, wherein the holding member includes a holder that is opposite to the energy storage unit in the first direction, and the first joint joins the energy storage unit and the holder.

14. The energy storage apparatus according to claim 3, wherein the outer case includes an outer case body and an outer case lid, the holding member includes a holder that is opposite to at least one of the outer case body and the outer case lid, and the second joint joins at least one of the outer case body and the outer case lid and the holder.

15. The energy storage apparatus according to claim 14, wherein the outer case body and the outer case lid are arrayed in a second direction intersecting with the first direction, the holder is opposite to at least one of the outer case body and the outer case lid in the second direction, and the second joint joins at least one of the outer case body and the outer case lid and the holder in the second direction.

16. The energy storage apparatus according to claim 3, wherein the holding member includes a pair of holders positioned between the energy storage unit and a wall of the outer case on both sides in the first direction, and each of the pair of holders is positioned away from the wall and forms a gap with the wall in the first direction.

17. The energy storage apparatus according to claim 4, wherein the outer case includes an outer case body and an outer case lid, the holding member includes a second holder that is opposite to at least one of the outer case body and the outer case lid, and the second joint joins at least one of the outer case body and the outer case lid and the second holder.

18. The energy storage apparatus according to claim 17, wherein the outer case body and the outer case lid are arrayed in a second direction intersecting with the first direction, the second holder is opposite to at least one of the outer case body and the outer case lid in the second direction, and the second joint joins at least one of the outer case body and the outer case lid and the second holder in the second direction.

19. The energy storage apparatus according to claim 4, wherein the holding member includes a pair of holders positioned between the energy storage unit and a wall of the outer case on both sides in the first direction, and each of the pair of holders is positioned away from the wall and forms a gap with the wall in the first direction.

20. The energy storage apparatus according to claim 5, wherein the holding member includes a pair of holders positioned between the energy storage unit and a wall of the outer case on both sides in the first direction, and each of the pair of holders is positioned away from the wall and forms a gap with the wall in the first direction.
